(19) United States
(12) Patent Application Publication
(10) Pub. No.: US 2004/0093707 A1
(43) Pub. Date: May 20, 2004

(54) Combination of support post assembly and tools supported thereby

(75) Inventors: Vinode Ramnauth, Caledon East (CA); Leon Gimelschtein, Thornhill (CA)

Correspondence Address: LAW OFFICE OF BARRY R LIPSITZ, 755 MAIN STREET, MONROE, CT, 06468, US

(73) Assignee: PRO-LINE AUTOMATION SYSTEMS LTD., Concord (CA)

(21) Appl. No.: 10/635,693

(22) Filed: Aug. 5, 2003

Related U.S. Application Data
(60) Provisional application No. 60/427,241, filed on Nov. 19, 2002.

(51) Int. Cl. B23Q 16/02

(52) U.S. Cl. 29/39

(57) ABSTRACT

A post assembly for providing a selected tool member from a plurality of tool members and using the tool member in a machine operation is provided. The assembly includes a support post rotatable about its longitudinal axis and extending vertically during use from a bottom end to a top end thereof. Tool members each have a first end section and a second end section and each are pivotably attached at their first end section to the post in the vicinity of the top end. Each tool member is pivotable from a first position used for storage to a working position where the selected tool member extends radially outwardly from the support post. A linearly movable actuating member is able to selectively pivot any one of the tool members from the first position to the working position. A bearing arrangement supports the support post for rotation about its longitudinal axis and a power drive is operatively connected to a lower section of the post in order to rotate same about its longitudinal axis.

### BACKGROUND OF THE INVENTION

This application claims priority on the basis of earlier U.S. Provisional Patent Application No. 60/427,241 filed Nov. 19, 2002.

This invention relates to machine tools and, in particular, assemblies for supporting one or more tool members for use in a machine operation, and also relates to a tool device for mounting in a tool supporting assembly.

Automated machines for manufacturing and finishing plastic structures such as window frames are already well known in the window manufacturing industry. The machines that are used include not only plastic welding machines but also machines for cleaning weld seams using special cutting tools. A variety of devices for holding these cutting tools are known in the window making industry. For example, vinyl window frames are generally composed of four frame members attached at the corners by welding. The four members generally are cut at a 45 degree angle to each end prior to the ends being welded together. An automated welding machine for such windows generally leaves welding beads along the seams and these beads must be removed in order to provide a frame with a pleasing appearance. Special cutting tools can be used for this purpose and generally there are several steps involved in the so-called “cleaning process”.

It is known to provide a two head corner cleaner for the purpose of cleaning the corners of a welded vinyl window frame. A two head corner cleaner is able to carry out a cleaning or cutting operation on a welded window frame by means of two separate tool supporting heads. A corner cleaner of this type is available, for example, from Pro-Line Automation Systems Inc. of Brampton, Ontario, Canada.

A corner cleaning machine is described and illustrated in recent U.S. Pat. No. 5,448,819 to Macum Tooling Equipment Mfg. Ltd. This apparatus has a work surface and a clamping device on the work surface for holding an assembled work piece thereon. A cutting tool is provided on the work surface for removing access weld material from the workpiece corner, this tool being movable in an arcuate path around the apex of the corner of the window frame whereby excess material is removed from the corner. In this machine, a cutter block for removing the weld bead is mounted on the spindle of an electrical motor.

U.S. Pat. No. 6,006,408 issued Dec. 28, 1999 to Wegoma, Inc. describes a vinyl weld seam cleaner having a fixed support head and a movable support head. The movable support head accommodates windows of varying width. Each support head has an upper and lower machine head that houses a tool head and the tool heads have interchangeable tools. The machine head and the tool head cooperate together to allow the tools to move in three dimensions. The tools are held by tool holders and the tools can be changed for different types of cleaning and machining operations.

It is an object of the present invention to provide a combination of support post assembly and tool members with the combination being able to provide a selected tool member from a plurality of tool members for use of the tool member in a machine operation, the combination also being reliable in its operation and adaptable to a variety of machining steps.

It is a further object of the present invention to provide a novel combination of support post assembly and tool members which is able to provide a selected tool member for a particular machine operation and which can be manufactured at a reasonable cost.

It is a further object of the present invention to provide a support apparatus for a plurality of tool members, this apparatus being capable of holding a selected one of the tool members in a working position for a machine operation and being capable of supporting a plurality of different tool members that may be required to complete a manufacturing process.

It is an additional object of the invention to provide a tool device for mounting on a tool supporting assembly which can be made at a reasonable cost and that includes a cutting tool head and an elongate tool holder adapted to rigidly support this tool head.

### SUMMARY OF THE INVENTION

According to a first aspect of the invention, a combination of support post assembly and tool members is capable of providing a selected tool member from a plurality of tool members for use of the tool member in a machine operation. The combination comprises a support post adapted for rotation about a longitudinal axis of the post during use of the combination and a plurality of tool members. Each tool member is pivotably attached to the post and is adapted to pivot from a first position used for storage to a working position where the respective tool member extends outwardly in a radial direction from the support post. The combination further includes a movable actuating member capable of selectively pivoting any one of the tool members from its first position to the working position.

Preferably the combination includes a bearing support extending around an end section of the support post and rotatably supporting the support post.

According to a further aspect of the invention, a combination of support post assembly and tool members is capable of providing a selected tool member from a plurality of tool members so that the tool member can be used in a machine operation. The combination comprises a support post adapted for rotation about a longitudinal axis thereof and a plurality of tool members. The post extends vertically during use thereof from a bottom end to a top end. Each tool member has a first end section and a second end section and each is pivotably attached at the first end section to the post in the vicinity of the top end thereof. Each tool member is capable of pivoting from a first position used for storage to a working position where the selected tool member extends rigidly outwardly from the support post. A linearly movable actuating member is provided to selectively pivot any one of the tool members from the first position to the working position and this actuating member is movably mounted in the support post. A bearing support arrangement is also provided to support the support post for rotation about its longitudinal axis. There is also a power drive system operatively connected to a lower section of the support post and capable of rotating same about its longitudinal axis during use of the combination.

In one preferred embodiment, the actuating member is an elongate rod extending through a central axial passageway formed in the support post and linearly movable therein.

According to another aspect of the invention, a support apparatus for a plurality of tool members capable of holding a selected one of the tool members for a machine operation includes a support post adapted for rotation about a longitudinal axis thereof. This post has an upper end section adapted for pivotably supporting the plurality of tool members and a lower section. A linearly movable actuating member is provided for selectively pivoting any one of the tool members from a first position used for storage to a working position where the selected tool member extends radially outwardly from the support post. The actuating member is movably mounted in the support post. A bearing support arrangement rotatably supports the support posts for rotation about its longitudinal axis. This support arrangement engages the lower section of the support post. A power drive system is operatively connected to the lower section of the support post and is capable of rotating the support post about its longitudinal axis.

Preferably this support apparatus includes a linear actuator operatively connected to a lower end section of the actuating member and adapted to move the actuating member selectively upwardly or downwardly relative to the post.

According to yet another aspect of the invention, a tool device for mounting in a tool supporting assembly for use in a machine operation includes a tool head suitable for carrying out the machine operation and an elongate tool holder having opposite first and second end sections. The first end section is adapted to rigidly support the tool head while the second end section has a flat end surface extending at an acute angle to a central longitudinal axis of the tool holder. There is also a recess formed on one side of the second end section to accommodate pivotal movement of the tool device. There is also means for forming a pivot axis located at the second end section, the pivot axis extending transversely relative to the central longitudinal axis.

Preferably the tool head is detachably connected to the tool holder by means of at least one threaded fastener.

Further features and advantages will become apparent from the following detailed description taken in conjunction with the accompanying drawings.

### BRIEF DESCRIPTION OF THE DRAWINGS

FIG. 1 is a side view of one embodiment of a combination support post assembly and tool members, this view including a major portion in vertical cross-section to show internal details;

FIG. 2 is a cross-sectional view taken along the line II-II of FIG. 1;

FIG. 3 is a side view similar to FIG. 1 but showing the cutting tool member in a raised, horizontal position;

FIG. 4 is a vertical cross-sectional view taken along the line IV-IV of FIG. 1, this view omitting the air cylinder at the bottom end;

FIG. 5A is a side elevation of the lower portion of a second embodiment of a support post assembly for tool members, this view being partially in cross-section for ease of illustration;

FIG. 5B is an axial cross-section of the upper portion of the second embodiment;

FIG. 6A is another side elevation of the lower portion of the second embodiment with only a portion above the gear housing being shown in cross-section;

FIG. 6B is a cross-sectional elevation of the second embodiment, this view showing the tool member on the left side in the lowered, storage position;

FIG. 7A is another cross-sectional elevation of a central section of the second embodiment, this cross-section being taken along the line VII-VII of FIG. 6A;

FIG. 7B is a cross-sectional elevation of the upper portion of the support post, this view also being taken along the line VII-VII of FIGS. 6A and 6B;

FIG. 8 is a horizontal cross-section of the upper end of the support post and six tool members mounted therein, this view being taken along the line VIII-VIII of FIG. 6B;

FIG. 9 is a detail top view, portions of which are in crosssection, this view being taken along the line IX-IX of FIG. 5A and showing the centering block for the rod 24;

FIG. 10 is a detail top view of the air cylinder mounting plate;

FIG. 11 is a bottom view, portions of which are in crosssection, taken along the line XI-XI of FIG. 6A, this view showing the lower cover plate of the gear housing and the clamp plate located therein;

FIG. 12 is a detail side elevation of the gear housing section and adjacent structure, this view being taken from the left side of FIG. 6A;

FIG. 13 is a top view of one side of a two head corner cleaner incorporating the combination of support post and tool members of the present invention;

FIG. 14 is a detail view in elevation of a portion of the corner cleaner of FIG. 13, this view being taken along the line XIV-XIV of FIG. 13; and

FIG. 15 is an elevational, detail view of a portion of the corner cleaner and the lower portion of the support post for the tool members, this view being taken along the line XV-XV of FIG. 14.

### DETAILED DESCRIPTION OF PREFERRED EMBODIMENTS

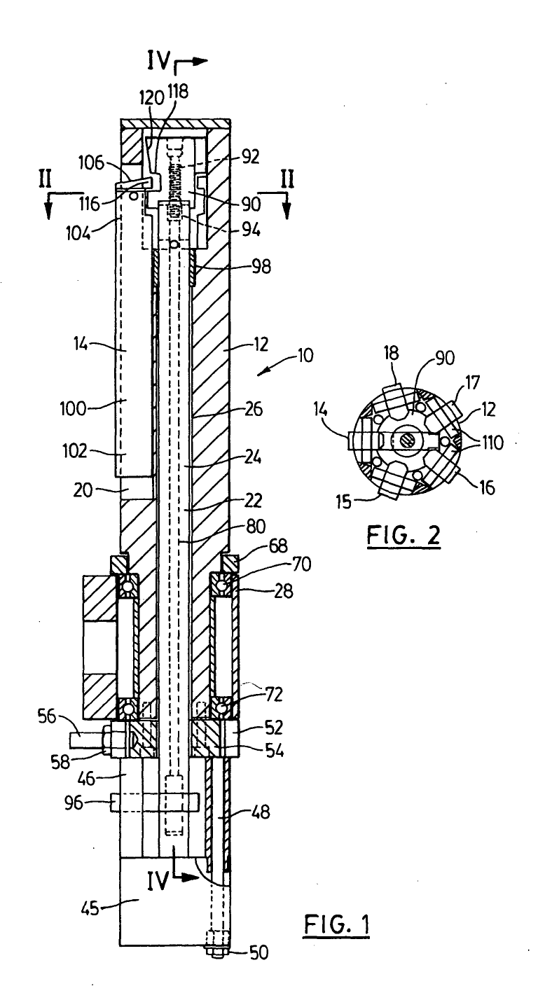

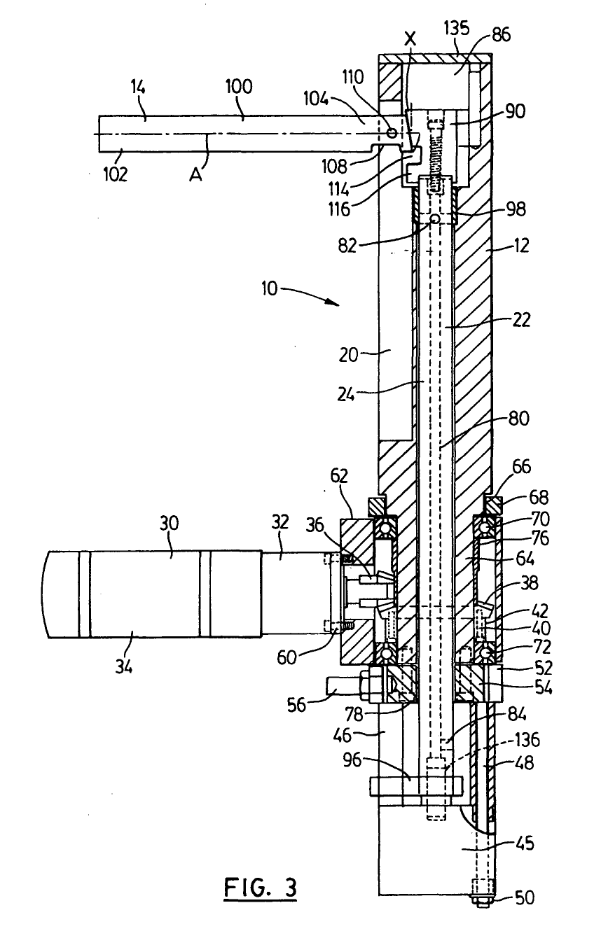

A first embodiment of a combination of support post assembly and tool members indicated generally at 10 is illustrated in FIGS. 1 to 4. Major components of this combination include a support post 12 adapted for rotation about a longitudinal axis of the post during use of the combination and a plurality of tool members 14 to 18, all five of which can be seen in FIG. 2. Each of these tool members is pivotably attached to the post 12 and it is adapted to pivot from a first position used for storage to a working position. The first position for the tool member 14 is illustrated in FIG. 1 and, as shown, in this position the tool member extends vertically and is located in its own tool holding recess 20 formed in the post 12. It will be understood that each of the tool members 14 to 18 can be provided with its own tool holding recess in the post. The working position for the tool member 14 is shown in FIG. 3 and, in the illustrated preferred embodiment, the tool member 14 extends outwardly in a radial direction from the support post in this working position.

Another major component of the combination is a movable actuating member indicated generally at 22 and capable of selectively pivoting any one of the tool members 14 to 18 from its first position to the working position. The preferred actuating member includes an elongate rod 24 that is non-rotatably mounted in a central passageway 26 extending along the longitudinal axis of the post.

The preferred combination 10 also has a bearing support arrangement indicated generally at 28 for supporting the post 12 for rotation about its longitudinal axis and a power drive system indicated generally at 30. The drive system is operatively connected to a lower section of the support post 12 and is capable of rotating the post about its longitudinal axis during use of the combination. The preferred, illustrated drive system includes a planetary gear head unit 32 and a servomotor 34 having its output shaft (not shown) connected to the gears in the head unit 32. The motor and the gear head unit can be rigidly supported on an adjacent support plate (not shown in FIGS. 1 and 3).

In one preferred embodiment, the gear head unit has a gear ratio of 1:10 and one gear head unit suitable for this purpose is that sold by CMI, Part No. 23EP010. A usable form of servomotor 34 operates on 400watt power and is made by Mitsubishi, Part No. HC-PQ43. It will be understood that the gear head unit turns a bevel gear 36 which rotates about a horizontal axis and turns a large bevel gear 38 that extends about a reduced diameter, lower end section of the support post. The gear 38 is mounted on this lower end section by means of screws 40 that extend through an annular gear spacer 42.

Another preferred component of the combination 10 is a pneumatic cylinder-type actuator 45. One suitable type of air cylinder actuator is that made by SMC, Part No. NCDQ2B40-25D. This preferred air cylinder actuator has a bore of 40 mm and a stroke of 25 mm and it operates and moves vertically the rod 24. The actuator 45 is preferably connected to the rod 24 by means of a standard short pusher rod 136 that extends upwardly from the pneumatic actuator as shown in dashed lines. The actuator 45 can be mounted at the bottom end of the post by means of four spacer sleeves or pillars 46 distributed about the circumference of the top of the actuator and four threaded rods 48, only one of which is visible in FIGS. 1 and 3. The threaded rods extend through the actuator housing and are connected to the bottom end of the housing by means of four nuts, one of which is shown at 50. The top ends of these rods are firmly connected to a rigid, annular cover plate 52. A round hole formed in the plate 52 accommodates a clamp plate 54. A sensor switch 56 is mounted on the cover plate 52 by means of a nut 58. The sensor switch 56 is able to sense the position of rotation of the post 12 at one end of its 355 degree range of rotation, namely at its home position.

The gear head unit is attached by screws 60 a gear housing 62. The gear housing can be made so that it has an internal supply of grease that will last for the design life of the housing and its internal components. This avoids the need for a grease nipple but one could be provided, if desired.

The lower portion of the post 12 has a reduced, circular crosssection on which the annular bevel gear 38 is mounted. In one preferred embodiment, this gear has forty-eight teeth and the driving gear 36 has sixteen teeth. Between the reduced section 64 of the post and the wider upper section is a short, intermediate section 66, the diameter of which is between that of the upper section and the reduced section 64. Mounted on this section is an annular cover plate 68 which rests against upper ball bearings 70 of a bearing support extending around a lower end section of the support post and rotatably supporting the post. The upper bearing 70 and a set of lower ball bearings 72 are mounted on the reduced section 64. These bearings are enclosed by the gear housing 62 which also encloses the gears 36 and 38. Extending between the top of the annular bevel gear 38 and the upper bearing is a bushing 76. Rotatably mounted below the lower bearing 72 is the annular clamp plate 54 which is fixedly attached by screws 78 to the bottom end of the post. Thus, this plate, which rotates with the post, supports the lower set of ball bearings 72.

The preferred rod 24 is an elongate tube having an air passageway 80 extending along its central axis. This passageway connects near its upper end to short, radial air passageways 82. Pressurized air is provided to the bottom end section of the passageway 80 through a short, radial passageway 84, which can be connected to a flexible air hose (not shown). The purpose of these air passageways is to provide a means to provide positive air pressure to a cavity 86 formed in the top of the post, this pressurized air helping to keep cut chips and debris from the cavity and away from the post. The pressurized air flows into a cavity in the top of the post when the actuating member 22 is raised to the position shown in FIG. 1.

The preferred actuating member further includes a headpiece 90 which acts as a form of wedge member as explained hereinafter and which is located in a cavity 86. The headpiece 90 is connected by means of a central screw 92 to the top end of the rod 24. The top of the cavity 86 can be covered by a circular end plate 135 which can be attached by screws to the top of the post. The bottom end of the screw is threaded into a threaded insert at 94 arranged in the top end of the rod. The rod 24 is prevented from rotating by means of a radially extending guide arm or block 96 located at the bottom end of the rod. This guide arm can be attached to the rod by means of a press fit. Although the guide arm or block 96 is free to move upwardly and downwardly a limited distance, as can be seen by comparing FIGS. 1 and 3, it is effectively prevented from rotating about the central axis of the rod by a vertically extending guide post. In the illustrated embodiment, one of the spacer sleeves 46 is used as the guide post. Also, note that the upper end of the rod, which is a form of control rod guiding or controlling the movement of each tool member, is slidably mounted in a bushing 98, thereby allowing rotation of the post about the rod.

The mechanism for rotating each tool arm from its lowered position to an extended working position will be explained with particular reference to FIG. 1 which shows the tool member 14 in the lowered or storage position, and FIG. 3 which shows the tool member in a radially extending, working position. Firstly, it will be appreciated that each tool member or tool device can be provided with a cutting tool head, such as a knife, suitable for carrying out the machine operation. A typical tool head is shown in subsequent figures illustrating a second embodiment of a combination of this invention. The tool member or tool device also includes an elongate tool holder 100 such as that illustrated in FIGS. 1 and 3. It is possible of course to combine the tool head and tool holder 100 into a single integral tool device, if desired. The elongate tool holder has a first end section 102 adapted to rigidly support the tool head and a second end section 104, the latter having a flat end surface 106 extending at an acute angle to a central longitudinal axis A of the tool holder. In the preferred version, the angle ranges between 8 and 10 degrees to a plane extending perpendicular to the central longitudinal axis. The tool arm or tool holder has a transversely extending recess 108 which is located on the bottom side of the arm when the arm is horizontal. This recess accommodates the pivotable movement of the tool device. The recess is formed in the second end section 104 of the tool holder. Each tool arm or tool holder is mounted at its inner end on a dowel pin 110 that extends through transversely extending hole formed in the second end section 104 of the tool member. The dowel pin or pivot pin fits snugly in this hole. It will thus be appreciated that the tool member such as member 14 is provided with means for forming a pivot axis located at the second end section 104, this pivot axis extending transversely relative to the central longitudinal axis. Preferably this pivot forming means is the illustrated dowel pin and the hole for this pin. Of course, it is also possible to form such pivot means in other ways, for example, by means of integral pivot members formed in the tool member itself.

The head piece 90 is formed with its own recess 114 on one vertical side and, in the lowered position of the adjacent tool arm, a lip 116 is accommodated loosely within this recess. The recess has a top surface 118 and projecting upwardly from the edge of this top surface at a small angle X to the vertical is an inclined engagement surface 120. The preferred range for this small angle X is eight to ten degrees. It is recommended that this angle not be less than eight degrees because if it is, there is a danger of self-locking that may make it difficult to move the tool arm back to its storage position.

When the head piece 90 is moved from its raised position shown in FIG. 1 to a lower position such as shown in FIG. 3, the lip 116 on the arm is engaged by the top surface 118, thereby causing the tool member to pivot upwardly to the horizontal position shown in FIG. 3. Once the tool member reaches the horizontal position, a slight, further downward movement of the headpiece will lock the arm in the horizontal cutting position or working position due to the engagement between the inclined surface 120 of the headpiece and the sloping end surface 106. The degree of slope on these two surfaces is matched so that the tool member is held in the required working position.

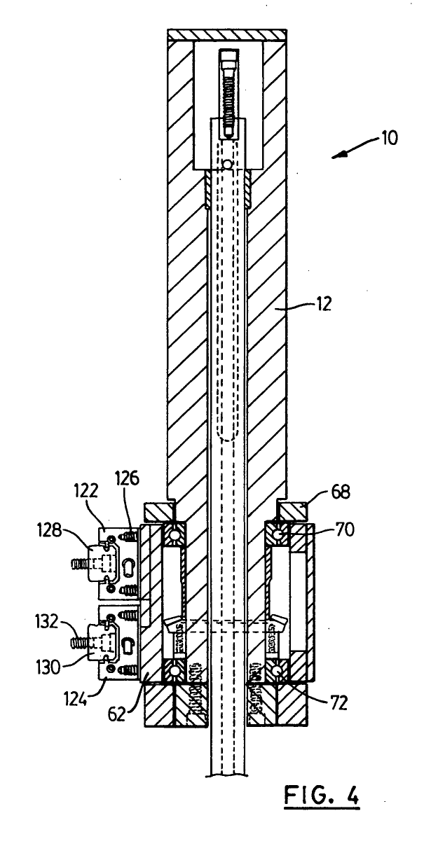

FIG. 4 illustrates how the post assembly and tool combination 10 can be mounted on two upper ball slides 122 and two lower ball slides 124. These ball slides are connected by screws 126 to the gear housing assembly. These ball slides are of standard construction and therefore a detailed description herein is deemed unnecessary. The two upper ball slides 122 are spaced apart in a horizontal direction and similarly with the two lower ball slides 124. The upper ball slides 122 are slidably mounted on an upper support bar 128 while the ball slides 124 are mounted on a lower support bar 130. The bars 128, 130 are attached by means of screws 132 to a suitable, vertical support surface (not shown). Thus, with this mounting arrangement, the combination 10 is mounted so that it can move easily in one horizontal direction along the bars 128, 130. It may be necessary, for example, to move the position of the combination 10 in order to work on work pieces of different sizes or to carry out a machine operation.

In this first embodiment, the number of cutting tools or tool members mounted on the support post is five but it will be understood that the number of tools mounted on the support posts could be fewer than five or more than five. In the second embodiment described hereinafter, the number of tool members is in fact six. It will be appreciated that the selected tool member which is raised to the working position by means of the actuating member, including the rod 24, is determined by the selected position to which the support post has been rotated about its central longitudinal axis. Thus, in the rotational position shown in FIGS. 1 and 3, the tool member 14 has been selected for pivoting from its storage position to its raised, working position. Any of the other tool members could also be selected for use in a machining operation by a suitable rotation of the support post. The required rotation of the post which is carried out by the servomotor and the gear head unit is done by means of a suitable computer program, if desired. The current location of the support post is provided to the computer or microprocessor by the sensor or sensor switch 56. As the construction and use of such a sensor switch is well known for an automated machine, a detailed description herein is deemed unnecessary.

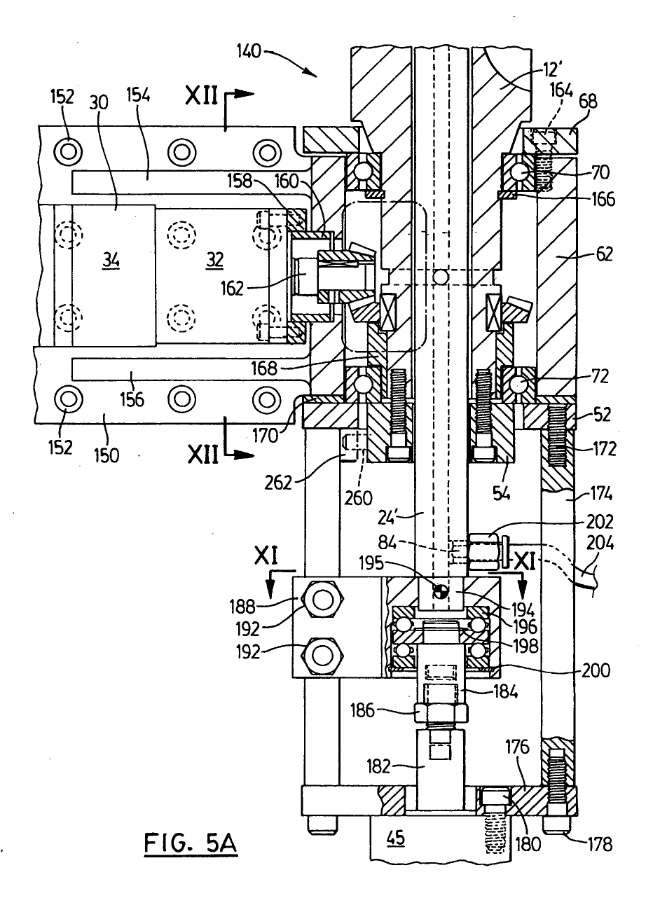

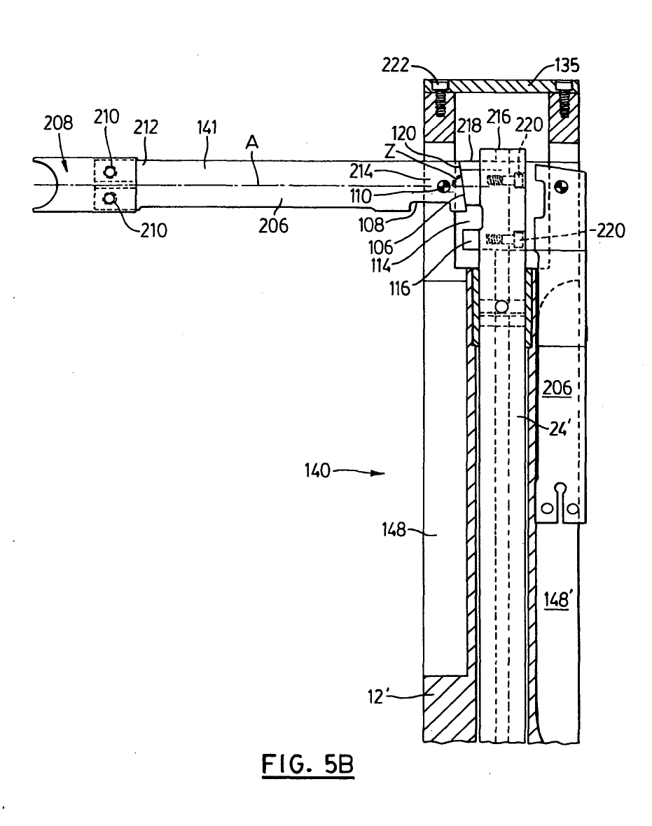

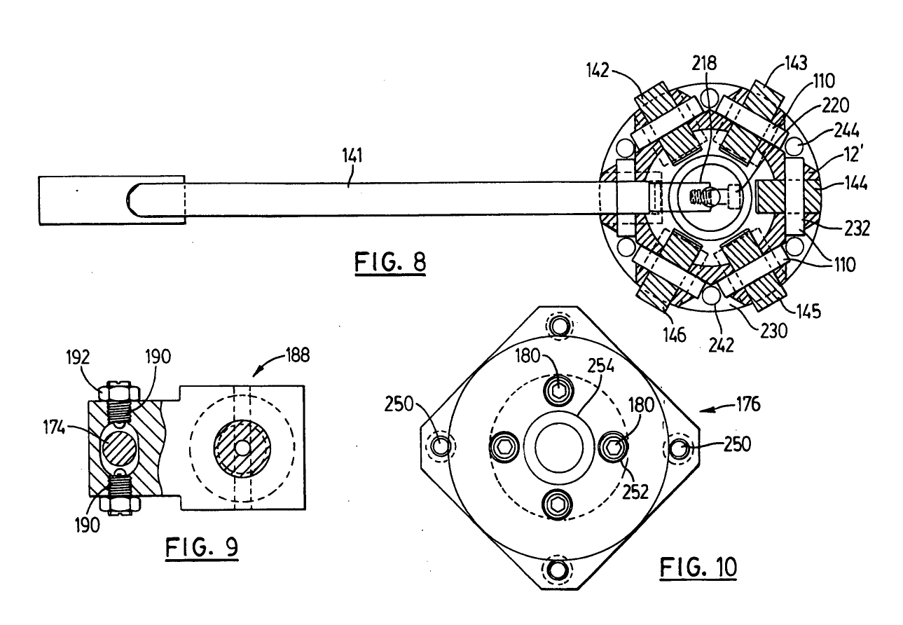

A second, preferred embodiment, of combination support post assembly and tool members is illustrated in FIGS. 5A to 11. This second embodiment is indicated generally by reference 140. This embodiment has many features in common with the first combination 10 illustrated in FIGS. 1 to 4 and accordingly only those features of the second embodiment which differ significantly from the features of the first embodiment already described will be described in detail hereinafter. One primary difference between the two embodiments is that the second embodiment, as illustrated, is provided with six tool members 141 to 146 as can be seen clearly from FIG. 8. Also there are six tool holding recesses 148 or 148′ formed about the circumference of the support post 12′.

Turning to FIG. 5A of the drawings, this view shows in partial cross-section the lower portion of the post and tool combination 140. The servomotor 34 is only partially shown for sake of illustration and in this preferred embodiment the servomotor is provided with a brake mechanism in a known manner. This preferred servomotor is available from Mitsubishi, Part No. HC-PQ43BK-UE. The servomotor and gear head unit are supported by motor mounting plate 158 which is arranged in a vertical plane. The servomotor and the adjoining gear head unit can be attached to this plate by a plurality of mounting screws. The gear housing 62 is firmly supported by and connected to the vertical support plate 150 which is connected to four ball slides (as explained below) by means of screws extending through a plurality of screw holes 152. A rigid connection can be provided between the plate 150 and the gear housing 62 by means of two, parallel, connecting plates 154, 156. These connecting plates can be welded along one edge to the plate 150 and along a second edge to the gear housing. Extending through a hole in the plate 158 is a cylindrical bushing 160. This bushing also extends into the side of the gear housing 62. Located in this bushing is an output shaft 162 of the planetary gear head on which the bevel gear 36 is mounted. A key is provided to fix the gear on the shaft.

Also, in this embodiment, the cover plate 68 is attached to the gear housing by means of screws 164. The upper ball bearing 70 is held in place in the gear housing by means of a retaining ring 166. Arranged next to and above the lower ball bearing 72 is a gear spacer 168. The lower ball bearing extends around the lower portion of this gear spacer which is of reduced diameter. Located at the bottom end of the gear housing is a relatively thin spacer plate 170 which sits on top of the lower cover plate 52. Mounted in the cover plate 52 are four set screws 172, only one of which is shown in FIG. 5A. These set screws are used to attach four solid posts 174 which extend vertically downwardly from the plate 52. Rigidly connected to the bottom end of these posts is a cylinder mounting plate 176. Four screws 178 extend through holes in the plate to connect the plate to the posts. Mounted to the bottom of this plate is the air cylinder actuator 45, only the upper portion of which is shown in FIG. 5A. Four screws 180 can be used to attach the actuator 45 to the plate.

The center of the plate 176 is formed with a hole for passage of a short actuator rod 182. Adjustably attached to the top of this rod is a short adjusting rod 184. A nut 186 is provided below this adjusting rod for vertical fine adjustment. The adjusting rod extends into an opening formed in a centering block 188, the details of which can also be seen in FIG. 9. This centering block is slidably mounted on one of the posts 174. Its. position and alignment on this post can be carefully adjusted by means of four spring plungers 190 with two being mounted on each of opposing sides of the centering block. These plungers are held in place by jam nuts 192. The top of the centering block is formed with an opening that snugly receives a reduced bottom end section 194 of the rod 24. A pin 195 secures the bottom end of the rod in the centering block. A cavity is formed in the centering block and in this cavity is a thrust ball bearing 196. Extending into this thrust ball bearing is a reduced end section of the adjusting rod 184, this reduced end being held in the bearing by means of a retaining ring 198, the latter engaging a groove in the reduced end. A further retaining ring 200 engages the bottom of the thrust bearing, which is a double direction bearing, and holds this bearing in the centering block. It will be appreciated that the provision of the thrust ball bearing 196 allows the rotation of the adjusting rod without affecting the fixed rotational position of the rod 24′ about its longitudinal axis.

Also shown in FIG. 5A is a male connector 202 which is used to connect pressurized air hose 204 to the opening 84 formed in the side of the rod 24′. The purpose of the air hose and opening 84 has already been described above in connection with the first embodiment.

Referring now to FIG. 5B which illustrates the upper portion of the support post 12′ and tool members pivotably attached thereto, it will first be noted that in this embodiment the post 12′ can be provided with an enlarged recess 148′, if desired. One or more of these enlarged recess can be provided to accommodate a larger tool member (not shown). The illustrated cavity 148′ in one preferred embodiment is provided to accommodate a drill tool which per se can be of standard construction. The drill tool can also be used to carry out a machine operation. This drill can be detachably connected to an elongate tool holder 206. The tool member or tool device 141 shown in its working position on the left side of FIG. 5B is equipped with a tool head 208, the illustrated tool head being a cutting or knife tool detachably connected to the tool holder by two threaded fasteners at 210. The tool holder 206 of tool member 141 has a first end section 212 which is adapted to rigidly support the tool head 208 and a second end section 214. This second end section is provided with the aforementioned flat end surface 106 that extends at an acute angle Z to a central longitudinal axis A of the tool holder.

Turning now to the construction of the top end section of the rod 24′ of this second embodiment, the rod member itself extends to the top end 216 of the elongate actuator. The upper end section of the rod 24′ is cut out to accommodate a wedge 218 which forms the inclined surface 120. The wedge is secured to the top of the rod by screws 220. The wedge also forms the lip 116 and the recess 114 about the lip. Also shown in FIG. 5B are screws 222 that can be used to attach the top end plate 135 to the post.

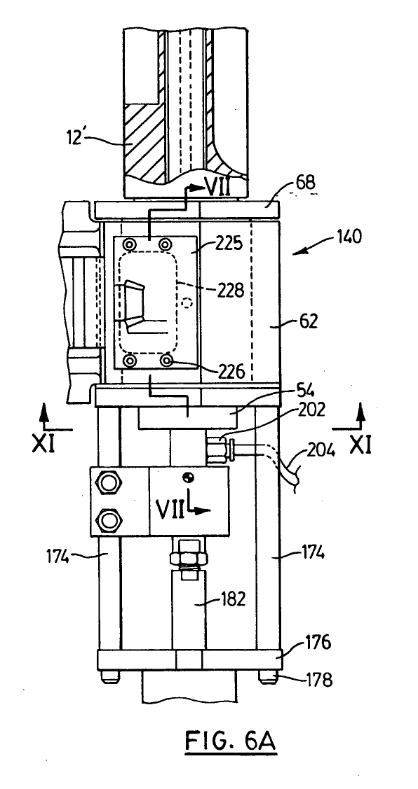

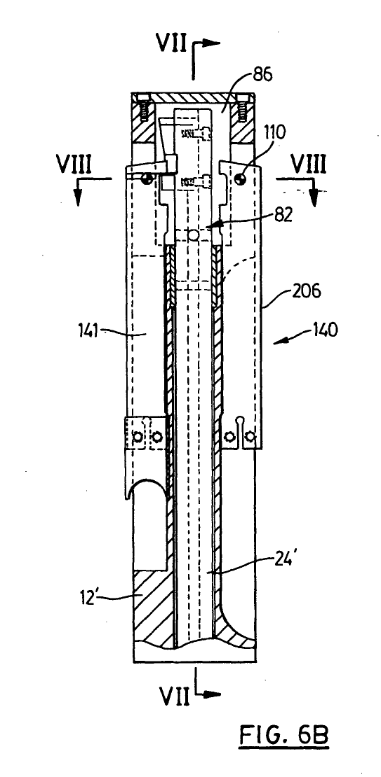

An additional feature shown in FIG. 6A is a gear housing cover plate 225. This plate can be attached to the side of the housing by means of screws 226. This plate is used to cover a rectangular opening 228 formed in one side of the gear housing, thereby allowing access into the interior of the housing and access to the bevel gears mounted therein.

FIG. 6B which shows the upper portion of the support post and tool combination 140 shows both the tool member 141 and the tool holder 206 in their lower or storage positions. In this view, the rod 24′ has been raised to its uppermost position. In this position the pressurized air holes or passageways 82 have been raised so that they are open to the interior of the cavity 86. Thus, in this position, pressurized air can keep stray chips and other debris from the cavity.

With reference to FIG. 8, this cross-sectional view shows how all six of the tool members are equally spaced about the central longitudinal axis of the post 12′. Preferably each of the tool members is pivotally mounted by means of the dowel pins 110 which extend snuggly into holes formed in the upper end section of the post. The upper end of the post can be formed with angular cutouts 230 which allow insertion of the dowel pins into their respective transversely extending holes 232 drilled in the post. The pins 110 are held in position by further vertically extending pins 244 as explained below.

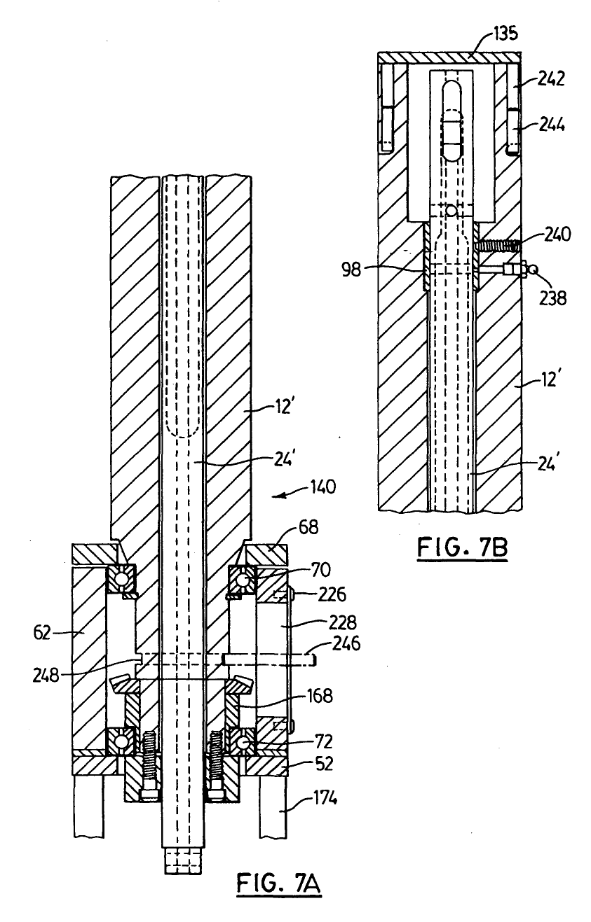

FIGS. 7A and 7B of the drawings provide another vertical cross-section of the support post (from the gear housing 62 up). Mounted in the upper section of the support post 12′ is a grease fitting 238 which permits grease to be provided through a passageway to the inside of bushing 98. The bushing is held in place by means of a set screw 240 with a dog point. An annular groove is formed about the interior of the bushing at the level of the grease fitting to permit the grease to be fed about the circumference of the bushing.

Located in vertical holes 242 that extend down from the top of the post 12′ are the six dowel pins 244. These pins are distributed evenly about the circumference of the support post and, as indicated, they are used to hold the horizontally extending dowel pins 110 in place.

Shown in dash lines in FIG. 7A is a pull dowel 246 which is used simply to locate the bevel gear 38 during the manufacturing process. The end of the dowel 246 is located in the annular groove 248 formed in the post. The bevel gear is then aligned and its spacer 168 is ground as required to properly position the gear. The pull dowel 246 is then removed.

With reference to FIG. 10, this view shows the top of the air cylinder mounting plate 176. The plate is substantially square but the four corners may be cut off as shown. Located in the cut-off corners of the plate are four holes 250 for the screws 178 that connect the posts 174. Also visible are four countersunk holes 252 which receive the screws 180 that are used to mount the air cylinder actuator. Located in the center of the plate is a circular hole 254 through which the actuating rod 182 extends.

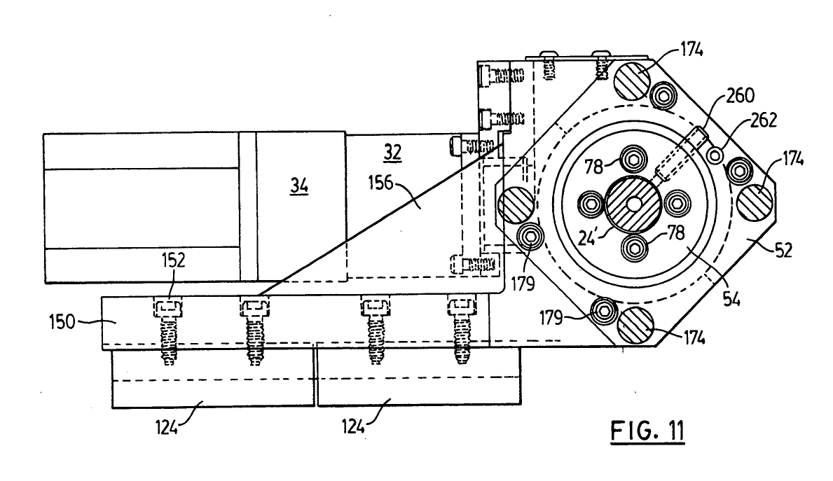

Turning now to FIG. 11 of the drawings, this bottom view is taken along the line XI-XI of FIG. 6A. This view shows the bottom of the substantially square lower cover plate 52, the four corners of which can be cut off as shown. Located in the four corners of this plate are the ends of the posts 174. Also shown is the circular clamp plate 54 and the four screws 78 that are used to attach this clamp plate. Extending through a hole in the center of the clamp plate is the rod 24′. Also shown on this figure are the four screws 179 used to attach the plate 52 to the bottom of the gear housing. The heads of these screws are located in four holes formed in the bottom of the plate 52. Located in the clamp plate and projecting therefrom is a dowel pin 260 and mounted next to this dowel pin is a vertical dowel pin 262, which is mounted in the cover plate 52 and projects downwardly therefrom. These dowel pins act together as a stop to prevent rotation of the post more than 360 degrees about its axis. In a preferred embodiment, rotation of the post is limited to 355 degrees of rotation. When the dowel 260 is in contact with the dowel 262, this is the “home” position from which the computer control measures and determines the amount of rotation.

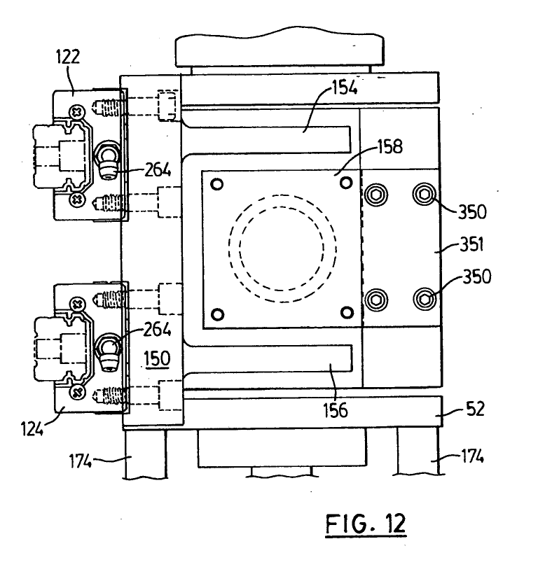

FIG. 12 is a detail side view of the gear housing and servomotor region of the apparatus. This view shows how the screws attach the support plate 150 to the two upper ball slides 122 and the two lower ball slides 124. These ball slides, which can be of standard construction, allow horizontal, linear movement of the support plate and the attached post and tool combination. There can be provided on ends of these ball slides grease fittings 264. Also shown are four attachment screws 350 that are used to connect a mounting plate for the servomotor 34. This mounting plate 351 is used to provide easier access to the motor mounting screws and to provide a position adjustment capability.

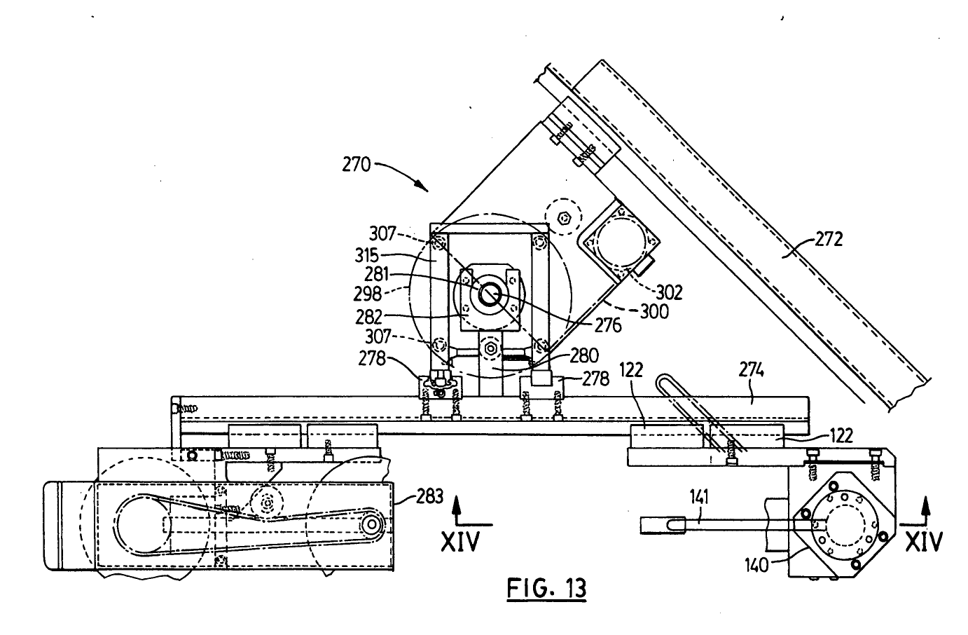

FIG. 13 illustrates one half of a two head corner cleaner indicated generally by 270 which can be used, for example, in the manufacture of welded, vinyl window frames. Except for the combination support posts and tool members of the present invention and the mounting for same as described herein, this corner cleaner can be constructed in a manner known per se. Such corner cleaners have been sold (without the support post combination and tool members of the present invention) in the past by Pro-Line Automation Systems Inc. of Brampton, Ontario, Canada. Accordingly, a detailed description of this two head corner cleaner herein is deemed unnecessary except for the description of the support post and tool member combination of the invention. The corner cleaner is mounted on a tubular support frame 272 (only a portion of which is shown for ease of illustration). Movably mounted on this support frame is a main support plate 274 which can be both pivoted about a vertical axis located at 276 and moved vertically up or down as explained hereinafter. The support plate 274 is supported on its rear surface by means of ball slides 278. Extending between these ball slides is a rigid support arm 280 on which is mounted a ball screw nut 281 by means of a nut holder 282. Also shown in FIG. 13 is a drill apparatus 283 including an electric motor for operating same, which is of known construction and does not form part of the present invention.

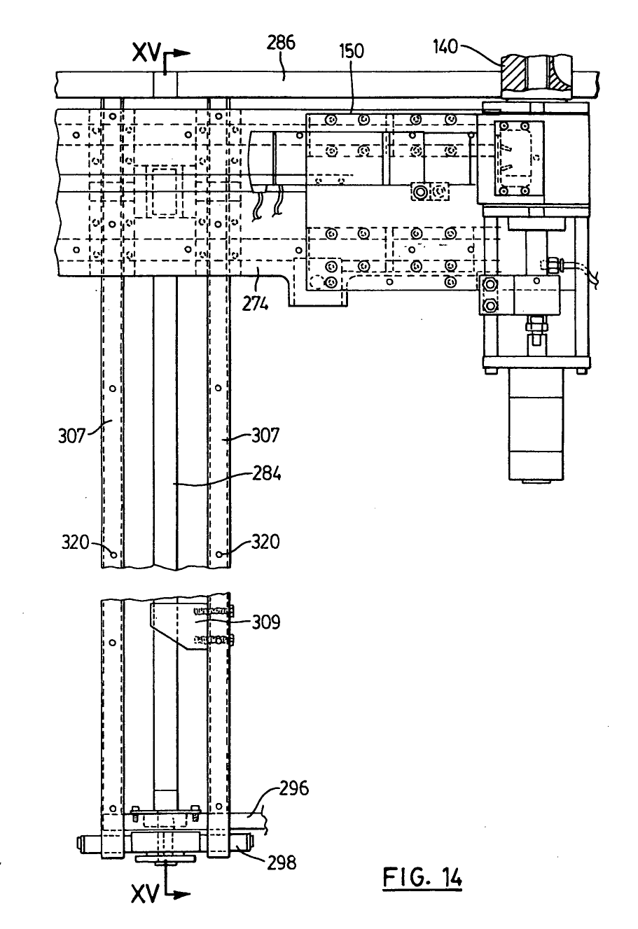

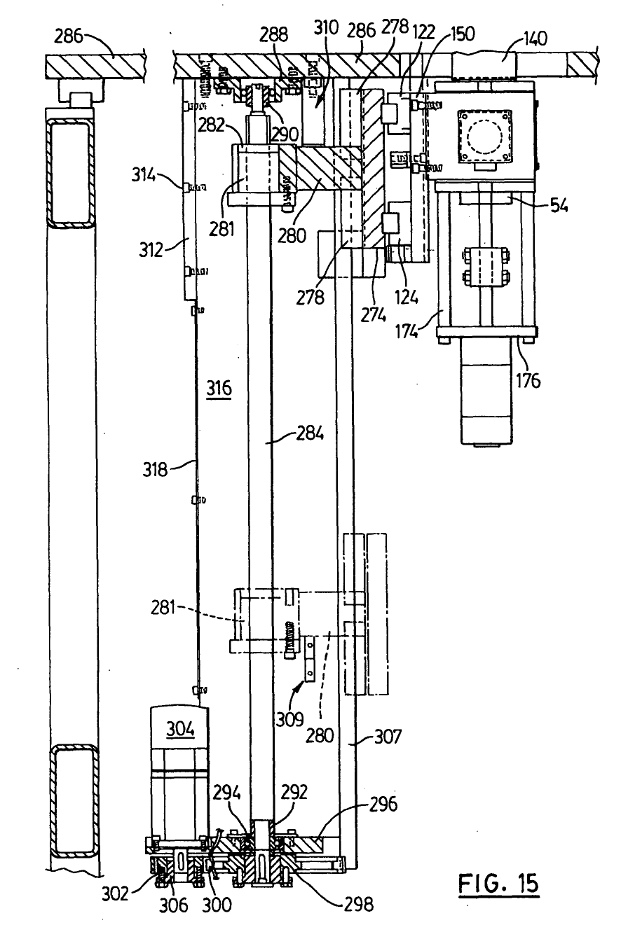

With reference now to FIGS. 14 and 15, there is shown a screw shaft 284 which extends through the ball screw nut 281. This shaft is rotatably mounted to horizontal support plate 286 by two flange units 288 which support a bearing mount 290. The bottom end of the screw shaft extends through a spacer 292 and a lower ball bearing 294 which is mounted in horizontal support plate 296. The end section of the screw shaft extends into a relatively large pulley 298 which is connected by means of a gear belt 300 (only a small portion of which is shown) to a smaller pulley 302. The smaller pulley is connected to the output shaft of a servomotor 304 by means of bushing 306. The servomotor 304 in one preferred embodiment is equipped with a brake and operates on 400 watt power. The support plate 296 is suitably supported in its horizontal position and can be connected to vertical rails 307 that in turn are connected at their top ends to the main support plate 286.

Shown in phantom lines on the screw shaft 284 is the lower position for the support arm 280 and the ball screw nut 281. This represents the lowest position for the combined support post and tool members 140. Further downward movement below this point is prevented by a bottom stop 309. The uppermost position of the support arm 280 is shown in solid lines in FIG. 15 and upward movement beyond this point is prevented by upper stop member 310 connected to the bottom of the plate 286. Also shown in FIG. 15 is vertical plate 312 which can be connected by screws 314 to a vertical plate 316 that extends downwardly from the plate 286 to the plate 296. Detachably mounted below the plate 312 is a thin cover plate 318. In one preferred embodiment of this two head corner cleaner, the amount of vertical movement of the support arm 280 and the support post combination connected thereto is 20 inches.

Turning now to FIG. 14, there are shown therein the two vertical rails 307 on which are slidably mounted the main support plate 274 by means of the ball slides. These rails are mounted on respective, vertical support plates 316 by means of screws at 320.

It will thus be seen that the combination 140 of the invention is able to be moved both a substantial distance vertically on the rails 307 and also is able to move horizontally by means of the horizontal rails on which the ball slides 122, 124 are mounted. It will thus be seen that the combination 140 can be used to carry out a variety of machining and/or cutting operations in a manufacturing process. It will be appreciated that the two head corner cleaner can be operated and controlled by either a programmable logic controller or a computer, the construction and operation of which are generally known in this industry. The programmable logic controller or computer can also be programmed to operate and control the combination of support post assembly and tool members of the invention.

It will be apparent to those skilled in the art that various modifications and changes can be made to the described embodiments of the invention without departing from the spirit and scope of this invention. Accordingly, all such modifications and changes as fall within the scope of the appended claims are intended to be part of this invention.

I claim:

1. A combination of support post assembly and tool members, said combination being capable of providing a selected tool member from a plurality of tool members for use of said tool member in a machine operation, said combination comprising:
a support post adapted for rotation about a longitudinal axis of said post during use of said combination;
a plurality of tool members each pivotally attached to said post and adapted to pivot from a first position used for storage to a working position where the respective tool member extends outwardly in a substantially radial direction from the support post; and
a movable actuating member capable of selectively pivoting any one of said tool members from said first position to said working position.

2. A combination according to claim 1 including a bearing support extending around an end section of said support post and rotatably supporting said support post.

3. A combination according to claim 2 wherein said actuating member includes an elongate rod that is non-rotatably mounted in a central passageway extending along said longitudinal axis of said post.

4. A combination according to claim 3 wherein said actuating member further includes a wedge provided on an upper end section of said elongate rod and having an inclined surface that extends upwardly and radially outwardly relative to a central longitudinal axis of said rod and wherein each tool member has an inclined end surface adapted for engagement with the inclined surface of said wedge when the respective tool member is pivoted towards its working position by said actuating member.

5. A combination according to claim 1 wherein said post is formed with a plurality of elongate, longitudinally extending recesses, one for each of said tool members, whereby each tool member lies substantially within its respective recess in its first position.

6. A combination according to claim 2 including a gear assembly for rotating said post about its longitudinal axis, said gear assembly including a gear fixedly mounted on said end section of the support post and extending around said end section.

7. A combination according to claim 6 including a servomotor operatively connected to said gear assembly and capable of rotating said gear, said servomotor being rigidly mounted on a gear housing apparatus in which said gear assembly is mounted.

8. A combination according to claim 3 including a pneumatic cylinder-type actuator having a movable pusher rod connected to said elongate rod mounted in said central passageway, said actuator including a pneumatic cylinder fixedly mounted on a support plate below said support post.

9. A combination according to claim 3 wherein said elongate rod has a central longitudinal air passageway formed therein and extending to an end section of said elongate rod located where said tool members are attached to said post, said air passageway being connectible to a source of pressurized air which is deliverable to a cavity formed in an end section of said support post, which surrounds said end section of the elongate rod, during use of said post assembly, the delivery of pressurized air providing positive air pressure in said cavity in order to keep chips and debris out of said cavity.

10. A combination according to claim 3 wherein said plurality of tool members comprises six different tool members each capable of carrying out a different machine operation.

11. A combination of support post assembly and tool members, said combination capable for providing a selected tool member from a plurality of tool members and for using said tool member in a machine operation, said combination comprising:
a support post adapted for rotation about a longitudinal axis of said post, which extends vertically during use of said post from a bottom end to a top end thereof;
a plurality of tool members each having a first end section and a second end section and each pivotally attached at said first end section to said post in the vicinity of said top end thereof, each tool member being capable of pivoting from a first position used for storage to a working position where the selected tool member extends substantially radially outwardly from the support post;
a linearly movable actuating member for selectively pivoting any one of said tool members from said first position to said working position, said actuating member being movably mounted in said support post;
a bearing support arrangement for supporting said support post for rotation about said longitudinal axis of said post; and
a power drive system operatively connected to a lower section of said support post and capable of rotating same about its longitudinal axis during use of said combination.

12. A combination according to claim 11 wherein said actuating member includes an elongate rod extending through a central axial passageway formed in said support post and linearly movable therein.

13. A combination according to claim 12 including a linear actuator connected to a lower end section of said elongate rod and adapted to move said elongate rod either upwardly or downwardly relative to said support post.

14. A combination according to claim 12 wherein said actuating member further includes a wedge member mounted on an upper end section of said elongate rod and having an inclined surface that extends upwardly and radially outwardly relative to a central longitudinal axis of said rod and wherein each tool member has a first end surface on said first end section, this end surface being inclined relative to a central longitudinal axis of the respective tool member and being arranged for firm engagement with said inclined surface of said wedge member when the respective tool member is pivoted to its working position.

15. A combination according to claim 11 wherein said power drive system includes a gear assembly, including a bevel gear rigidly mounted on and extending around said support post, and a servomotor having an output shaft operatively connected to said gear assembly and capable of driving same in order to rotate said support post.

16. A support apparatus for a plurality of tool members capable of holding a selected one of said tool members for a machine operation, said support apparatus comprising:
a support post adapted for rotation about a longitudinal axis of said post, said support post having an upper section adapted for pivotably supporting said plurality of tool members and a lower section;
a linearly movable actuating member for selectively pivoting any one of said tool members from a first position used for storage to a working position where the selected tool member extends substantially radially outwardly from the support post, said actuating member being movably mounted in said support post;
a bearing support arrangement rotatably supporting said support post for rotation about said longitudinal axis of the post, said support arrangement engaging said lower section of the support post; and
a power drive system operatively connected to said lower section of said support post and capable of rotating said support post about its longitudinal axis.

17. A support apparatus according to claim 16 wherein said actuating member includes an elongate rod extending through a longitudinal passageway formed in said support post and a wedge member mounted on an upper section of said elongate rod and having an inclined surface that extends upwardly and radially outwardly relative to a central longitudinal axis of said rod, said inclined surface being arranged to engage a co-operating surface formed on a selective one of the tool members in order to hold the selected tool member in an operating position during use of said support apparatus.

18. A support apparatus according to claim 17 including a linear actuator operatively connected to a lower end section of said elongate rod and adapted to move said elongate rod selectively upwardly or downwardly relative to said support post.

19. A support apparatus according to claim 18 wherein said power drive system includes a gear assembly, including a bevel gear rigidly mounted on and extending around said support post, and a servomotor having an output shaft operatively connected to said gear assembly and capable of driving same in order to rotate said support post.

20. A tool device for mounting in a tool supporting assembly for use in a machine operation, said tool device comprising:
a tool head suitable for carrying out said machine operation;
an elongate tool holder having opposite first and second end sections, said first end section being adapted to rigidly support said tool head, said second end section having a flat end surface extending at an acute angle to a central longitudinal axis of said tool holder and a recess formed on one side thereof to accommodate pivotal movement of said tool device; and
means for forming a pivot axis located at said second end section, said pivot axis extending transversely relative to said central longitudinal axis.

21. A tool device according to claim 20 wherein said tool head is detachably connected to said tool holder by means of at least one threaded fastener.

22. A tool device according to claim 20 wherein said pivot axis forming means includes a transversely extending hole formed in said second end section of the tool holder and a pivot pin adapted to fit snuggly in said hole.

23. A tool device according to claim 20 wherein said flat end surface extends from one side of tool holder to an opposite side thereof and extends at an acute angle ranging between 8 and 10 degrees to a plane extending perpendicular to said central longitudinal axis.
